(19) United States
(12) Patent Application Publication
(10) Pub. No.: US 2017/0094189 A1
(43) Pub. Date: Mar. 30, 2017

(54) ELECTRONIC APPARATUS, IMAGING METHOD, AND NON-TRANSITORY COMPUTER READABLE RECORDING MEDIUM

(71) Applicant: KYOCERA CORPORATION, Kyoto (JP)

(72) Inventor: Shinya OGAWA, Osaka (JP)

(21) Appl. No.: 15/273,516

(22) Filed: Sep. 22, 2016

(30) Foreign Application Priority Data
Sep. 28, 2015 (JP) 2015-189687

(51) Int. Cl. H04N 5/247; G03B 15/16; H04N 5/232

(52) U.S. Cl. CPC H04N 5/247; H04N 5/23216; H04N 5/23245; H04N 5/23293; G03B 15/16

(57) ABSTRACT

An electronic apparatus, an imaging method, and a non-transitory computer readable recording medium are disclosed. A first camera images a first imaging range. A second camera images a second imaging range having an angle wider than an angle of the first imaging range. At least one processor detects, based on an image signal from the second camera, a mobile object located in a partial area outside the first imaging range in the second imaging range. The at least one processor estimates at least one of a first timing at which a position of the mobile object coincides with a predetermined position within the first imaging range and a second timing at which the mobile object enters into the first imaging range.

### CROSS-REFERENCE TO RELATED APPLICATION

The present application claims priority under 35 U.S.C. §119 to Japanese Patent Application No. 2015-189687, filed on Sep. 28, 2015, entitled “ELECTRONIC APPARATUS AND IMAGING METHOD”. The content of which is incorporated by reference herein in its entirety.

### FIELD

Embodiments of the present disclosure relate to an electronic apparatus.

### BACKGROUND

Various techniques have conventionally been proposed for an electronic apparatus including a camera.

### SUMMARY

An electronic apparatus, an imaging method, and a non-transitory computer readable recording medium are disclosed. In one embodiment, an electronic apparatus comprises a first camera, a second camera, and at least one processor. The first camera images a first imaging range. The second camera images a second imaging range having an angle wider than an angle of the first imaging range. The at least one processor detects, based on an image signal from the second camera, a mobile object located in a partial area outside the first imaging range in the second imaging range. The at least one processor estimates at least one of a first timing at which a position of the mobile object coincides with a predetermined position within the first imaging range and a second timing at which the mobile object enters into the first imaging range.

In one embodiment, an imaging method comprises imaging a first imaging range by a first camera. A second imaging range having an angle wider than an angle of the first imaging range is imaged by a second camera. A mobile object located in a partial area outside the first imaging range in the second imaging range is detected based on an image signal from the second camera. At least one of a first timing and a second timing is estimated. At the first timing, a position of the mobile object coincides with a predetermined position within the first imaging range. At the second timing, the mobile object enters into the first imaging range.

In one embodiment, a non-transitory computer readable recording medium stores a control program for controlling an electronic apparatus including a first camera configured to image a first imaging range and a second camera configured to image a second imaging range having an angle wider than an angle of the first imaging range. The control program causes the electronic apparatus to detect, based on an image signal from the second camera, a mobile object located in a partial area outside the first imaging range in the second imaging range, and to estimate at least one of a first timing at which a position of the mobile object coincides with a predetermined position in the first imaging range and a second timing at which the mobile object enters into the first imaging range.

### BRIEF DESCRIPTION OF THE DRAWINGS

FIG. 1 illustrates a perspective view schematically showing an example of an external appearance of an electronic apparatus.

FIG. 2 illustrates a rear view schematically showing the example of the external appearance of the electronic apparatus.

FIG. 3 illustrates an example of an electrical configuration of the electronic apparatus.

FIG. 4 schematically illustrates a relationship between a first imaging range and a second imaging range.

FIG. 5 illustrates a flowchart showing an example operation of the electronic apparatus.

FIG. 6 illustrates an example display of a display screen.

FIG. 7 illustrates an example of a wide-angle live view image.

FIG. 8 illustrates an example display of the display screen.

FIG. 9 illustrates a flowchart showing an example operation of the electronic apparatus.

FIG. 10 illustrates an example of the wide-angle live view image.

FIG. 11 illustrates an example display of the display screen.

FIG. 12 illustrates a flowchart showing an example operation of the electronic apparatus.

FIG. 13 illustrates a flowchart showing an example operation of the electronic apparatus.

FIG. 14 illustrates a flowchart showing an example operation of the electronic apparatus.

FIG. 15 illustrates an example of the wide-angle live view image.

FIG. 16 illustrates a flowchart showing an example operation of the electronic apparatus.

FIG. 17 illustrates an example of the wide-angle live view image.

FIG. 18 illustrates an example of the wide-angle live view image.

FIG. 19 illustrates an example display of the display screen.

FIG. 20 illustrates an example display of the display screen.

### DETAILED DESCRIPTION

### First Embodiment

External Appearance of Electronic Apparatus

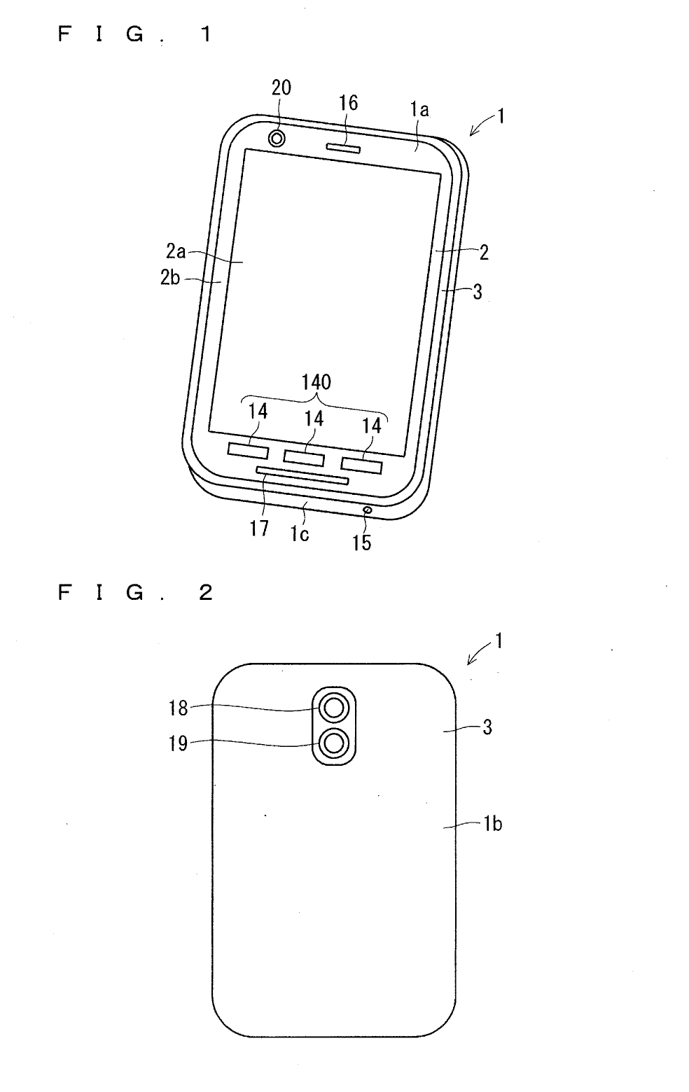

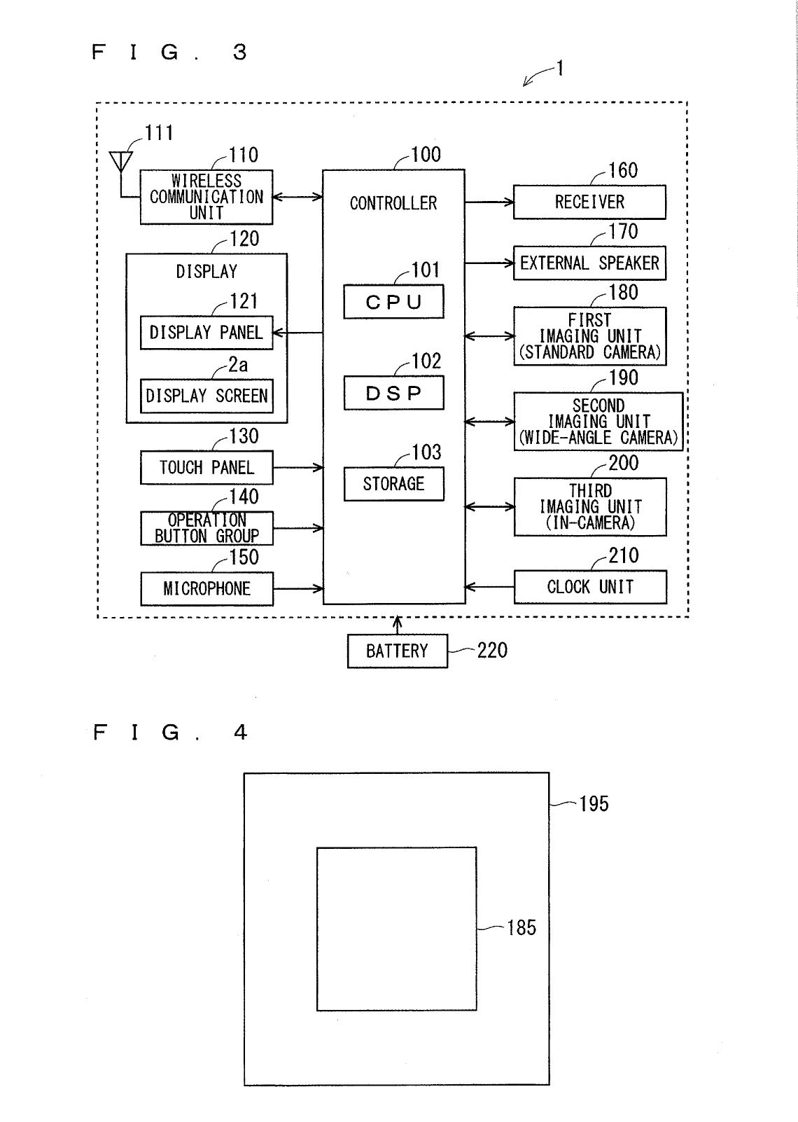

FIG. 1 illustrates a perspective view schematically showing an example of an external appearance of an electronic apparatus 1. FIG. 2 illustrates a rear view schematically showing the example of the external appearance of the electronic apparatus 1. The electronic apparatus 1 is, for example, a mobile phone such as a smartphone. The electronic apparatus 1 can communicate with another communication apparatus through a base station, a server, and the like.

As illustrated in FIGS. 1 and 2, the electronic apparatus 1 includes a cover panel 2 located on a front surface 1 a of the electronic apparatus 1 and an apparatus case 3 to which the cover panel 2 is attached. The cover panel 2 and the apparatus case 3 constitute an outer package of the electronic apparatus 1. The electronic apparatus 1 has, for example, a plate shape substantially rectangular in a plan view.

The cover panel 2 is provided with a display screen (display area) 2a on which various types of information such as characters, symbols, and diagrams displayed by a display panel 121, which will be described below, are displayed. A peripheral part 2b surrounding the display screen 2a in the cover panel 2 is mostly black through, for example, application of a film. Most of the peripheral part 2b of the cover panel 2 accordingly serves as a non-display area on which the various type of information, which are displayed by the display panel 121, are not displayed.

Attached to a rear surface of the display screen 2a is a touch panel 130, which will be described below. The display panel 121 is attached to the surface opposite to the surface on the display screen 2a side of the touch panel 130. In other words, the display panel 121 is attached to the rear surface of the display screen 2a through the touch panel 130. The user can accordingly provide various instructions to the electronic apparatus 1 by operating the display screen 2a with an operator such as a finger. The positional relationship between the touch panel 130 and the display panel 121 is not limited to the relationship described above. In one example configuration, a part of the configuration of the touch panel 130 may be buried in the display panel 121 as long as an operation performed on the display screen 2a with an operator can be detected.

As illustrated in FIG. 1, provided in an upper-side end portion of the cover panel 2 is a third-lens transparent part 20 that enables a lens of a third imaging unit 200, which will be described below, to be visually recognized from the outside of the electronic apparatus 1. Provided in the upper-side end portion of the cover panel 2 is a receiver hole 16. Provided in a lower-side end portion of the cover panel 2 is a speaker hole 17. Additionally, a microphone hole 15 is located in a bottom surface 1c of the electronic apparatus 1, or, a bottom surface (a lower side surface) of the apparatus case 3.

As illustrated in FIG. 2, provided in a back surface 1b of the electronic apparatus 1, or, in an upper-side end portion of a back surface of the apparatus case 3 is a first-lens transparent part 18 that enables an imaging lens of a first imaging unit 180, which will be described below, to be visually recognized from the outside of the electronic apparatus 1. Provided in the upper-side end portion of the back surface of the apparatus case 3 is a second-lens transparent part 19 that enables an imaging lens of a second imaging unit 190, which will be described below, to be visually recognized from the outside of the electronic apparatus 1. The first-lens transparent part 18 and the second-lens transparent part 19 are located in the back surface of the apparatus case 3 side by side along a longitudinal direction of the apparatus case 3. The positions at which the first-lens transparent part 18 and the second-lens transparent part 19 are provided are not limited to those of the example of FIG. 2. For example, the first-lens transparent part 18 and the second-lens transparent part 19 may be located side by side along a transverse direction of the apparatus case 3.

Provided inside the apparatus case 3 is an operation button group 140 including a plurality of operation buttons 14. Each operation button 14 is a hardware button such as a press button. The operation button may be referred to as an “operation key” or a “key”. Each operation button 14 is exposed from, for example, a lower-side end portion of the cover panel 2. The user can provide various instructions to the electronic apparatus 1 by operating each operation button 14 with the finger or the like.

The plurality of operation buttons 14 include, for example, a home button, a back button, and a history button. The home button is an operation button for causing the display screen 2a to display a home screen (initial screen). The back button is an operation button for switching the display of the display screen 2a to its previous screen. The history button is an operation button for causing the display screen 2a to display a list of the applications executed by the electronic apparatus 1.

Electrical Configuration of Electronic Apparatus

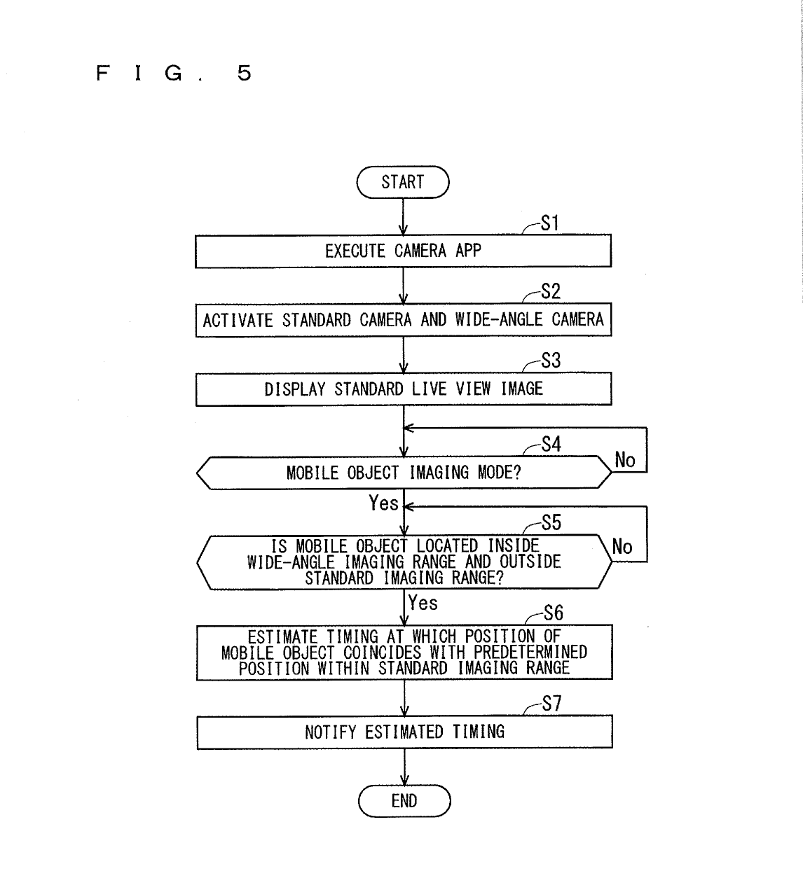

FIG. 3 illustrates a block diagram showing an example of an electrical configuration of the electronic apparatus 1. As illustrated in FIG. 3, the electronic apparatus 1 includes a controller 100, a wireless communication unit 110, a display 120, a touch panel 130, an operation button group 140, and a microphone 150. The electronic apparatus 1 further includes a receiver 160, an external speaker 170, a first imaging unit 180, a second imaging unit 190, a third imaging unit 200, a clock unit 210, and a battery 220. The apparatus case 3 houses each of these components provided in the electronic apparatus 1.

The controller 100 can control the other components of the electronic apparatus 1 to perform overall control of the operation of the electronic apparatus 1. The controller 100 includes at least one processor for providing control and processing capability to perform various functions as described in further detail below. In accordance with various embodiments, the at least one processor may be implemented as a single integrated circuit (IC) or as multiple communicatively coupled IC's and/or discrete circuits. It is appreciated that the at least one processor can be implemented in accordance with various known technologies.

In one embodiment, the processor includes one or more circuits or units configurable to perform one or more data computing procedures or processes by executing instructions stored in an associated memory, for example. In other embodiments, the processor may be implemented as firmware (e.g., discrete logic components) configured to perform one or more data computing procedures or processes.

In accordance with various embodiments, the processor may include one or more processors, controllers, microprocessors, microcontrollers, application specific integrated circuits (ASICs), digital signal processors, programmable logic devices, field programmable gate arrays, or any combination of these devices or structures, or other known devices and structures, to perform the functions described herein.

In one embodiment, the controller 100 includes, for example, a central processing unit (CPU) 101, a digital signal processor (DSP) 102, and a storage 103.

The storage 103 includes a non-transitory recording medium readable by the

CPU 101 and the DSP 102 such as a read only memory (ROM) and a random access memory (RAM). The ROM of the storage 103 is, for example, a flash ROM (flash memory) that is a non-volatile memory. The storage 103 mainly stores a main program for controlling the electronic apparatus 1 and a plurality of application programs (also merely referred to as “applications” or “apps” hereinafter). The CPU 101 and the DSP 102 execute the various programs in the storage 103 to achieve various functions of the controller 100. The storage 103 stores, for example, a call application for performing a voice call and a video call and an application for capturing a still image or video (also referred to as a “camera app” hereinafter) using the first imaging unit 180, the second imaging unit 190, or the third imaging unit 200.

The storage 103 may include a non-transitory computer readable recording medium other than the ROM and the RAM. The storage 103 may include, for example, a compact hard disk drive and a solid state drive (SSD). All or some of the functions of the controller 100 may be achieved by hardware that needs no software to achieve the functions above.

The wireless communication unit 110 includes an antenna 111. The wireless communication unit 110 can receive, for example, a signal from a mobile phone different from the electronic apparatus 1 or a signal from a communication apparatus such as a web server connected the Internet through the antenna 111 via a base station. The wireless communication unit 110 can amplify and down-convert the signal received by the antenna 111 and then output a resultant signal to the controller 100. The controller 100 can, for example, modulate the received signal to acquire information such as a sound signal indicative of the voice or music contained in the received signal.

The wireless communication unit 110 can also up-convert and amplify a transmission signal generated by the controller 100 to wirelessly transmit the processed transmission signal from the antenna 111. The transmission signal from the antenna 111 is received, via the base station, by the mobile phone different from the electronic apparatus 1 or the communication apparatus such as the web server connected to the Internet.

The display 120 includes the display panel 121 and the display screen 2a. The display panel 121 is, for example, a liquid crystal panel or an organic electroluminescent (EL) panel. The display panel 121 can display various types of information such as characters, symbols, and graphics under the control of the controller 100. The various types of information, which the display panel 121 displays, are displayed on the display screen 2a.

The touch panel 130 is, for example, a projected capacitive touch panel. The touch panel 130 can detect an operation performed on the display screen 2a with the operator such as the finger. When the user operates the display screen 2a with the operator such as the finger, an electrical signal corresponding to the operation is entered from the touch panel 130 to the controller 100. The controller 100 can accordingly specify contents of the operation performed on the display screen 2a based on the electrical signal from the touch panel 130, thereby performing the process in accordance with the contents. The user can also provide the various instructions to the electronic apparatus 1 by operating the display screen 2a with, for example, a pen for capacitive touch panel such as a stylus pen, instead of the operator such as the finger.

When the user operates each operation button 14 of the operation button group 140, the operation button 14 outputs to the controller 100 an operation signal indicating that the operation button 14 has been operated. The controller 100 can accordingly determine, based on the operation signal from each operation button 14, whether the operation button 14 has been operated. The controller 100 can perform the operation corresponding to the operation button 14 that has been operated. Each operation button 14 may be a software button displayed on the display screen 2a instead of a hardware button such as a push button. In this case, the touch panel 130 detects the operation performed on the software button, so that the controller 100 can perform the process corresponding to the software button that has been operated.

The microphone 150 can convert the sound from the outside of the electronic apparatus 1 into an electrical sound signal and then output the electrical sound signal to the controller 100. The sound from the outside of the electronic apparatus 1 is, for example, taken inside the electronic apparatus 1 through the microphone hole 15 provided in the bottom surface (lower side surface) of the apparatus case 3 and entered to the microphone 150.

The external speaker 170 is, for example, a dynamic speaker. The external speaker 170 can convert an electrical sound signal from the controller 100 into a sound and then output the sound. The sound output from the external speaker 170 is, for example, output to the outside of the electronic apparatus 1 through the speaker hole 17 located in the lower-side end portion of the cover panel 2. The sound output from the speaker hole 17 is set to a volume high enough to be heard in the place apart from the electronic apparatus 1.

The receiver 160 comprises, for example, a dynamic speaker. The receiver 160 can convert an electrical sound signal from the controller 100 into a sound and then output the sound. The receiver 160 can output, for example, the received sound. The sound output from the receiver 160 is output to the outside through the receiver hole 16 located in the upper-side end portion of the cover panel 2. The volume of the sound output from the receiver hole 16 is, for example, set to be lower than the volume of the sound output from the external speaker 170 through the speaker hole 17.

The receiver 160 may be replaced with a piezoelectric vibration element. The piezoelectric vibration element can vibrate based on a voice signal from the controller 100. The piezoelectric vibration element is provided in, for example, a rear surface of the cover panel 2 and can vibrate, through its vibration based on the sound signal, the cover panel 2. When the user brings the cover panel 2 close to his/her ear, the vibration of the cover panel 2 is transmitted to the user as a voice. The receiver hole 16 is not necessary when the receiver 160 is replaced with the piezoelectric vibration element.

The clock unit 210 can clock the current time and also clock the current date. The clock unit 210 includes a real time clock (RTC). The clock unit 210 can output to the controller 100 the time information indicating the time of the clock and the date information indicating the date of the clock.

The battery 220 can output a power source for the electronic apparatus 1. The battery 220 is, for example, a rechargeable battery such as a lithium-ion secondary battery. The battery 220 can supply a power source to various electronic components such as the controller 100 and the wireless communication unit 110 of the electronic apparatus 1.

Each of the first imaging unit 180, the second imaging unit 190, and the third imaging unit 200 comprises a lens and an image sensor. Each of the first imaging unit 180, the second imaging unit 190, and the third imaging unit 200 can image an object under the control of the controller 100, generate a sill image or a video showing the imaged object, and then output the sill image or the video to the controller 100. The controller 100 can store the received still image or video in the non-volatile memory (flash memory) or the volatile memory (RAM) of the storage 103.

The lens of the third imaging unit 200 can be visually recognized from the third-lens transparent part 20 located in the cover panel 2. The third imaging unit 200 can thus image an object located on the cover panel 2 side of the electronic apparatus 1, or, the front surface 1a side of the electronic apparatus 1. The third imaging unit 200 above is also referred to as an “in-camera”. Hereinafter, the third imaging unit 200 may be referred to as the “in-camera 200”.

The lens of the first imaging unit 180 can be visually recognized from the first-lens transparent part 18 located in the back surface 1b of the electronic apparatus 1. The lens of the second imaging unit 190 can be visually recognized from the second-lens transparent part 19 located on the back surface 1b of the electronic apparatus 1. The first imaging unit 180 and the second imaging unit 190 can thus image an object located on the back surface 1b side of the electronic apparatus 1. Each of the first imaging unit 180 and the second imaging unit 190 above may also be referred to as an “out-camera”.

The second imaging unit 190 can image a second imaging range with an angel (angle of view) wider than that of the first imaging range imaged by the first imaging unit 180. In one embodiment, when the first imaging unit 180 and the second imaging unit 190 respectively image the first and second imaging ranges, the angle of view of the second imaging unit 190 is wider than the angle of view of the first imaging unit 180.

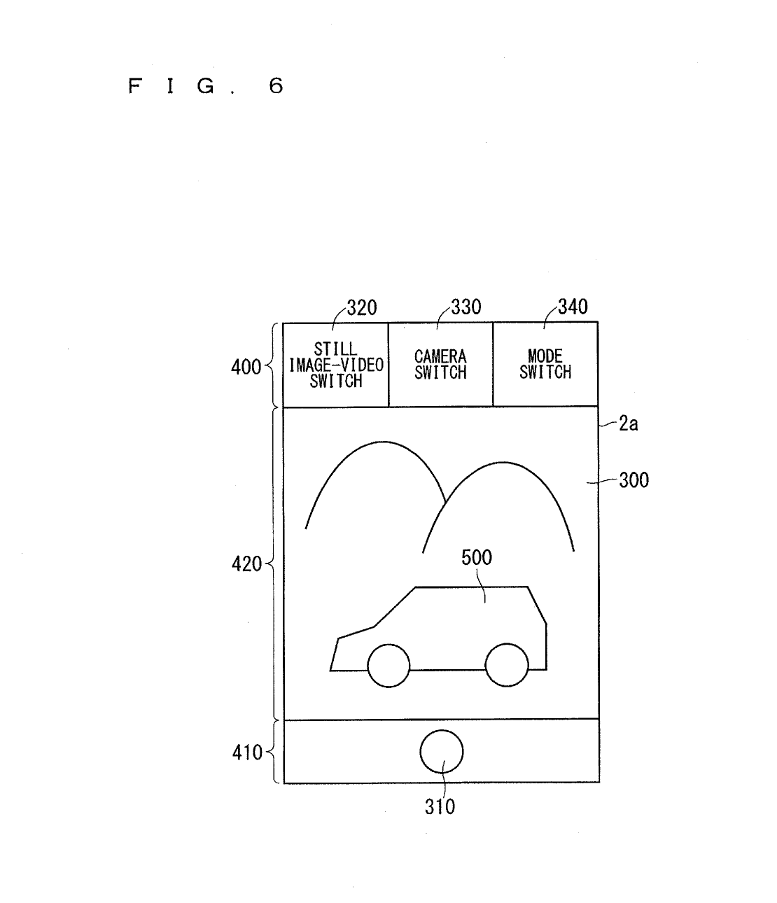

FIG. 4 schematically illustrates the relationship between the first imaging range 185 and the second imaging range 195 when the first imaging unit 180 and the second imaging unit 190 respectively image a first imaging range 185 and a second imaging range 195. As illustrated in FIG. 4, when the first imaging unit 180 and the second imaging unit 190 respectively image the first imaging range 185 and the second imaging range 195, the second imaging range 195 is larger than the first imaging range 185 and includes the first imaging range 185.

For the sake of description, the first imaging unit 180 is referred to as a “standard camera 180”, and the second imaging unit 190 is referred to as a “wide-angle camera 190”. The first imaging range 185 imaged by the standard camera 180 is referred to as a “standard imaging range 185”, and the second imaging range 195 imaged by the wide-angle camera 190 is referred to as a “wide-angle imaging range 195”.

In one embodiment, the respective lenses of the standard camera 180, the wide-angle camera 190, and the in-camera 200 are fixed-focal-length lenses. Alternatively, at least one of the lenses of the standard camera 180, the wide-angle camera 190, and the in-camera 200 may be a zoom lens.

The electronic apparatus 1 has a zoom function for each of the standard camera 180, the wide-angle camera 190, and the in-camera 200. In other words, the electronic apparatus 1 has a standard camera zoom function of zooming in or out an object to be imaged by the standard camera 180, a wide-angle camera zoom function of zooming in or out an object to be imaged by the wide-angle camera 190, and an in-camera zoom function of zooming in or out an object to be imaged by the in-camera 200. When an object to be imaged is zoomed in by the camera zoom function, the imaging range becomes smaller; when an object to be imaged is zoomed out by the camera zoom function, the imaging range becomes larger.

In one embodiment, each of the lenses of the standard camera 180, the wide-angle camera 190, and the in-camera 200 is a fixed-focal-length lens, and accordingly, each of the standard camera zoom function, the wide-angle camera zoom function, and the in-camera zoom function is a digital zoom function. Alternatively, at least one of the standard camera zoom function, the wide-angle camera zoom function, and the in-camera zoom function may be an optical zoom function achieved by a zoom lens.

In the case in which the electronic apparatus 1 has the standard camera zoom function and the wide-angle camera zoom function, or, each of the standard camera 180 and the wide-angle camera 190 has a variable angle of view, when the first imaging unit 180 and the second imaging unit 190 respectively image the first imaging range 185 and the second imaging range 195, the angle of view of the second imaging unit 190 is wider than the angle of view of the first imaging unit 180. Specifically, when the standard camera 180 and the wide-angle camera 190 each have a zoom magnification “1”, the wide-angle imaging range 195 has an angle wider than that of the standard imaging range 185. For example, when the standard camera 180 images the standard imaging range 185, the wide-angle camera zoom function of the electronic apparatus 1 may be disabled. In other words, when the standard camera 180 images the standard imaging range 185, the zoom magnification of the wide-angle camera 190 may be fixed to “1”. Thus, when the standard camera 180 images the standard imaging range 185, the fixed angle of view of the wide-angle camera 190 is wider than the maximum angle of view of the standard camera 180.

When the standard camera 180 does not image the standard imaging range 185 and the wide-angle camera 190 images the wide-angle imaging range 195, the wide-angle camera zoom function of the electronic apparatus 1 is enabled. When the wide-angle camera zoom function is enabled, the minimum angle of view of the wide-angle camera 190 may be smaller than the maximum angle of view of the standard camera 180.

In one embodiment, the number of pixels of an image showing an object located within the standard imaging range 185, which is imaged by the standard camera 180, is greater than the number of pixels of a partial image which is included in an image showing an object within the wide-angle imaging range 195 which is imaged by the wide-angle camera 190 and which corresponds to the standard imaging range 185. The partial image shows the object located within the standard imaging range 185. The user can accordingly image an objected located within the standard imaging range 185 with the standard camera 180 when the user wants to image the object with a higher definition (higher pixel density) and image the object with the wide-angle camera 190 when the user wants to image the object with a wider angle.

Imaging Modes

The electronic apparatus 1 has a mobile object imaging mode and a mobile object non-imaging mode as its imaging modes in imaging a still image with the standard camera 180. The mobile object imaging mode can be used when the user wants to image a mobile object, and the mobile object non-imaging mode can be used when the user does not want to image a mobile object.

In some cases, the user images a mobile object with the standard camera 180. For example, the user turns the standard camera 180 toward the place through which a mobile object conceivably passes, and waits for a timing at which the mobile object enters into the standard imaging range 185 to press a shutter button. As a result, a still image showing the mobile object within the standard imaging range 185 can be obtained. The mobile object imaging mode is an imaging mode for easily obtaining an image showing a mobile object in the imaging situation as described above.

When the user images a to-be-imaged object with the standard camera 180, another mobile object different from the to-be-imaged object may move toward the standard imaging range 185. In this case, the user can press the shutter button before the timing at which the other mobile object enters into the standard imaging range 185 to obtain an image not showing the other mobile object in the standard imaging range 185. The mobile object non-imaging mode is an imaging mode for easily obtaining an image not showing a mobile object that is not to be imaged in such an imaging situation.

When imaging a still image with the standard camera 180, the electronic apparatus 1 has a normal imaging mode other than the mobile object imaging mode and the mobile object non-imaging mode. In place of having three modes including the mobile object imaging mode, the mobile object non-imaging mode, and the normal imaging mode, the electronic apparatus 1 may have two modes including the mobile object imaging mode and the normal imaging mode or may have two modes including the mobile object non-imaging mode and the normal imaging mode.

Operation of Electronic Apparatus during Execution of Camera App

1-1. Operation of Electronic Apparatus in Mobile Object Imaging Mode

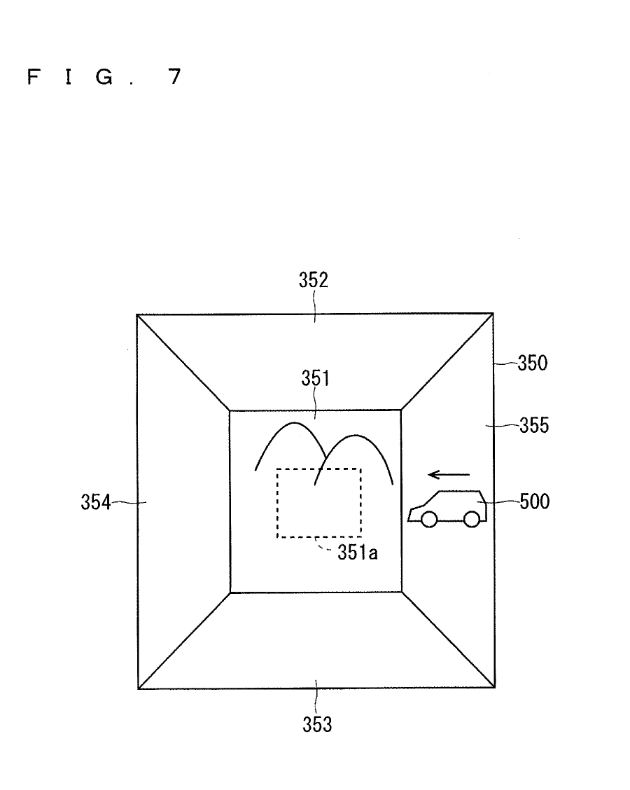

FIG. 5 illustrates a flowchart showing an example operation of the electronic apparatus 1 having the mobile object imaging mode and the normal imaging mode. When a predetermined operation is performed on the display screen 2a, as illustrated in FIG. 5, in step S1, the controller 100 executes (activates) a camera app stored in the storage 103. For example, a home screen (initial screen) is displayed on the display screen 2a in the initial state before the electronic apparatus 1 executes various apps. On the home screen are displayed a plurality of graphics for executing the various apps (hereinafter, also referred to as app-execution graphics). The app-execution graphics may include graphics referred to as icons. When the touch panel 130 detects a user's selection operation on the app-execution graphics for executing a camera app displayed on the display screen 2a, the controller 100 executes the camera app stored in the storage 103.

Conceivable as the selection operation on the app-execution graphics displayed on the display screen 2a is an operation in which the user brings the operator such as the finger close to the app-execution graphics and then moves the operator away from the app-execution graphics. Also, conceivable as the selection operation on the app-execution graphics displayed on the display screen 2a is an operation in which the user brings the operator such as the finger into contact with the app-execution graphics and then moves the operator away from the app-execution graphics. These operations are called tap operations. The selection operation through this tap operation is used as the selection operation on the app-execution graphics, as well as the selection operation on various pieces of information such as software buttons displayed on the display screen 2a. The following will not repetitively describe the selection operation through the tap operation.

When the camera app is not executed, the standard camera 180, the wide-angle camera 190, and the in-camera 200 do not operate. In other words, no power source is supplied to the standard camera 180, the wide-angle camera 190, and the in-camera 200.

When starting the execution of the camera app, in step S2, the controller 100 supplies a power source to the standard camera 180 and the wide-angle camera 190 among the standard camera 180, the wide-angle camera 190, and the in-camera 200, to thereby activate the standard camera 180 and the wide-angle camera 190. When the standard camera 180 and the wide-angle camera 190 are activated, the standard camera 180 serves as a recording camera for recording a captured still image or video in a non-volatile memory, and the wide-angle camera 190 serves as a camera for performing the operation of detecting a mobile object, which will be described below.

After step S2, in step S3, the controller 100 controls the display panel 121 to cause the display screen 2a to display a live view image (also referred to as a through image or a preview image, or merely referred to as a preview) showing the standard imaging range 185 imaged by the standard camera 180. In other words, the controller 100 causes the display screen 2a to display images, which are continuously captured at a predetermined frame rate by the standard camera 180, in real time. The live view image is an image displayed for the user to check images captured continuously at predetermined time intervals in real time. While a still image and a video for recording, which will be described below, are stored in the non-volatile memory of the storage 103, a live view image is temporarily stored in the volatile memory of the storage 103 and then displayed on the display screen 2a by the controller 100. Hereinafter, the live view image captured by the standard camera 180 is also referred to as a “standard live view image”.

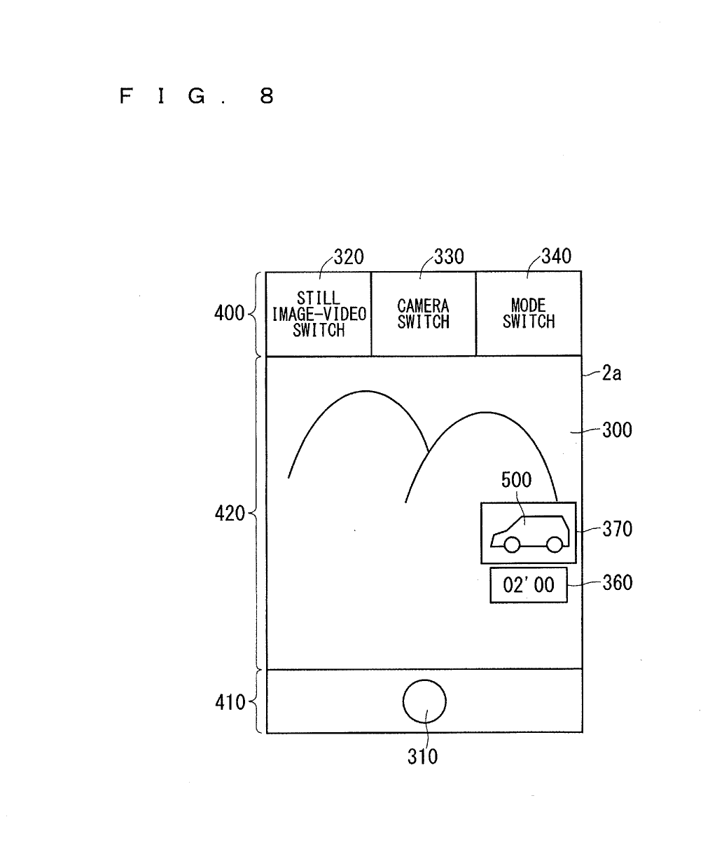

FIG. 6 illustrates an example display of the display screen 2a on which a standard live view image 300 is displayed. As illustrated in FIG. 6, the standard live view image 300 is displayed in a central area 420 (an area other than an upper end portion 400 and a lower end portion 410) of the display screen 2a. In other words, an object within the standard imaging range 185, which is continuously captured by the standard camera 180, is displayed in the central area 420 of the display screen 2a.

During the execution of the camera app, as illustrated in FIG. 6, an operation button 310 is displayed in the lower end portion 410 of the display screen 2a. On the upper end portion 400 of the display screen 2a are displayed a still image-video switch button 320, a camera switch button 330, and a mode switch button 340.

The still image-video switch button 320 is an operation button for switching the imaging mode of the electronic apparatus 1 between a still image capturing mode and a video capturing mode. In the case in which the imaging mode of the electronic apparatus 1 is the still image capturing mode, when the touch panel 130 detects a predetermined operation (e.g., a tap operation) on the still image-video switch button 320, the controller 100 switches the imaging mode of the electronic apparatus 1 from the still image capturing mode to the video capturing mode. In the case in which the imaging mode of the electronic apparatus 1 is the video capturing mode, when the touch panel 130 detects a predetermined operation on the still image-video switch button 320, the controller 100 switches the imaging mode of the electronic apparatus 1 from the video capturing mode to the still image capturing mode.

The camera switch button 330 is an operation button for switching a recording camera for recording a still image or a video. In the case in which the recording camera is the standard camera 180, when the touch panel 130 detects a predetermined operation (e.g., a tap operation) on the camera switch button 330, the controller 100 switches the recording camera from the standard camera 180 to, for example, the wide-angle camera 190. When the recording camera is switched from the standard camera 180 to the wide-angle camera 190, the controller 100 stops supplying a power source to the standard camera 180 to stop the operation of the standard camera 180. When the recording camera is switched from the standard camera 180 to the wide-angle camera 190, the display 120 displays a live view image showing the wide-angle imaging range 195 imaged by the wide-angle camera 190, in place of the standard live view image 300 (hereinafter referred to as a wide-angle live view image), on the display screen 2a.

In the case in which the recording camera is the wide-angle camera 190, when the touch panel 130 detects a predetermined operation on the camera switch button 330, the controller 100 switches the recording camera from the wide-angle camera 190 to, for example, the in-camera 200. When the recording camera is switched from the wide-angle camera 190 to the in-camera 200, the controller 100 supplies a power source to the in-camera 200 to activate the in-camera 200. The controller 100 then stops supplying a power source to the wide-angle camera 190 to stop the operation of the wide-angle camera 190. When the recording camera is switched from the wide-angle camera 190 to the in-camera 200, the display 120 displays a live view image captured by the in-camera 200, in place of a wide-angle live view image, on the display screen 2a.

In the case in which the recording camera is the in-camera 200, when the touch panel 130 detects a predetermined operation on the camera switch button 330, the controller 100 switches the recording camera from the in-camera 200 to, for example, the standard camera 180. When the recording camera is switched from the in-camera 200 to the standard camera 180, the controller 100 supplies a power source to the standard camera 180 and the wide-angle camera 190 to activate the standard camera 180 and the wide-angle camera 190, respectively. The controller 100 then stops supplying a power source to the in-camera 200 to stop the operation of the in-camera 200. When the recording camera is switched from the in-camera 200 to the standard camera 180, the display 120 displays a standard live view image 300, in place of a live view image captured by the in-camera 200, on the display screen 2a.

The recording camera during the execution of a camera app may be the wide-angle camera 190 or the in-camera 200, instead of the standard camera 180. The order of switching the recording cameras by the camera switch button 330 is not limited to the order in the example above.

The display 120 may display two camera switch buttons for switching over to two cameras other than the recording camera among the standard camera 180, the wide-angle camera 190, and the in-camera 200, in place of the camera switch button 330 for sequentially switching the recording cameras, on the display screen 2a.

The mode switch button 340 is an operation button for switching the imaging mode of the electronic apparatus 1 between the mobile object imaging mode and the normal imaging mode when the standard camera 180 is activated and the imaging mode of the electronic apparatus 1 is the still image capturing mode. The mode switch button 340 is displayed only when the standard camera 180 is activated and the imaging mode of the electronic apparatus 1 is the still image capturing mode.

In the case in which the standard camera 180 is activated and the imaging mode of the electronic apparatus 1 is the still image capturing mode, when the touch panel 130 detects a predetermined operation (e.g., a tap operation) on the mode switch button 340, the controller 100 switches the imaging mode of the electronic apparatus 1 from the normal imaging mode to the mobile object imaging mode. In the case in which the imaging mode of the electronic apparatus 1 is the mobile object imaging mode, when the touch panel 130 detects a predetermined operation on the mode switch button 340, the controller 100 switches the imaging mode of the electronic apparatus 1 from the mobile object imaging mode to the normal imaging mode.

As described below, when the electronic apparatus 1 has two modes including the mobile object non-imaging mode and the normal imaging mode, the mode switch button 340 serves as an operation button for switching the imaging mode of the electronic apparatus 1 between the mobile object non-imaging mode and the normal imaging mode. When the electronic apparatus 1 has three modes including the mobile object imaging mode, the mobile object non-imaging mode, and the normal imaging mode, the mode switch button 340 serves as an operation button for switching the imaging mode of the electronic apparatus 1 among the mobile object imaging mode, the mobile object non-imaging mode, and the normal imaging mode. The operations of the electronic apparatus 1 in the mobile object imaging mode and the mobile object non-imaging mode will be described below in detail.

In place of activating the wide-angle camera 190 in the case in which the recording camera is the standard camera 180, the standard camera 180 and the wide-angle camera 190 may be activated when the electronic apparatus 1 operates in the mobile object imaging mode and the mobile object non-imaging mode, and the standard camera 180 may be activated without activation of the wide-angle camera 190 when the electronic apparatus 1 operates in the normal imaging mode. The power consumption of the electronic apparatus 1 can accordingly be reduced.

In the case in which the imaging mode of the electronic apparatus 1 is the still image capturing mode, the operation button 310 functions as a shutter button. When the imaging mode of the electronic apparatus 1 is the video capturing mode, the operation button 310 functions as an operation button to start or stop capturing a video. In the case in which the imaging mode is the still image capturing mode, when the touch panel 130 detects a predetermined operation (e.g., a tap operation) on the operation button 310, the controller 100 stores a still image for recording, which is captured by the recording camera when the operation button 310 is operated and differs from the live view image, in the non-volatile memory of the storage 103, and causes the display screen 2a to display the still image.

In the case in which the imaging mode of the electronic apparatus 1 is the video capturing mode, when touch panel 130 detects a predetermined operation (e.g., a tap operation) on the operation button 310, the controller 100 starts storing a video for storing, which is captured by the recording camera and differs from the live view image, in the non-volatile memory of the storage 103. After that, when the touch panel 130 detects a predetermined operation on the operation button 310, the controller 100 stops storing a video for recording, which is captured by the recording camera, in the non-volatile memory of the storage 103.

The operation mode of the recording camera differs among when a still image for recording is captured, when a video for recording is captured, and when a live view image is captured. Thus, for example, the number of pixels of an image captured and an exposure time differ among the respective operation modes. For example, a still image for recording has more pixels than a video for recording and a live view image.

After step S3 illustrated in FIG. 5, in step S4, the controller 100 determines whether the electronic apparatus 1 is operating in the mobile object imaging mode. If a negative determination is made in step S4, step S4 is performed again. If not operating in the mobile object imaging mode, the electronic apparatus 1 operates in the normal imaging mode.

If an affirmative determination is made in step S4, step S5 is performed. In step S5, the controller 100 determines whether a mobile object is located inside the wide-angle imaging range 195 and outside the standard imaging range 185. Specifically, for example, the controller 100 performs image processing, such as detection of a moving object based on an inter-frame difference, on a series of input images continuously entered at a predetermined frame rate from the wide-angle camera 190, to thereby detect the position, moving direction, and moving speed of the mobile object in each input image. In this detection process, for example, a wide-angle live view image is used which is output from the wide-angle camera 190 and stored in the volatile memory of the storage 103.

For example, the central coordinates of an area of each input image in which a mobile object is located are detected as the position of the mobile object. The moving direction of the mobile object is detected based on, for example, the respective positions of the mobile object in two continuous input images. The moving speed of the mobile object is detected based on, for example, a moving amount of the mobile object, which is calculated in accordance with the respective positions of the mobile object in the two continuous input images captured at a predetermined time interval (e.g., the number of pixels of an input image for which the mobile object has moved). As described above, the controller 100 functions as a detection unit that detects the position, moving direction, and moving speed of the mobile object moving within the wide-angle imaging range 195.

Then, when the detected position of the mobile object is in the partial area outside the area corresponding to the standard imaging range 185 in the wide-angle imaging range 195 (the area showing an object within the standard imaging range 185), the controller 100 determines that the mobile object is located inside the wide-angle imaging range 195 and outside the standard imaging range 185.

When the mobile object is not detected and when the detected position of the mobile object is within the area corresponding to the standard imaging range 185 (the area showing the object within the standard imaging range 185), the controller 100 determines that the mobile object is located neither inside the wide-angle imaging range 195 nor outside the standard imaging range 185. As described above, the controller 100 functions as a determination unit that determines whether the mobile object is located inside the wide-angle imaging range 195 and outside the standard imaging range 185.

In step S5, if the controller 100 determines that the mobile object is located neither inside the wide-angle imaging range 195 nor outside the standard imaging range 185, step S5 is performed again. In other words, in step S5, the process of detecting a mobile object is performed until the controller 100 determines that the mobile object is located inside the wide-angle imaging range 195 and outside the standard imaging range 185. This process is performed, for example, every predetermined period of time.

If the controller 100 determines in step S5 that the mobile object is located inside the wide-angle imaging range 195 and outside the standard imaging range 185, step S6 is performed. In step S6, the controller 100 estimates a first timing at which the position of the mobile object, which has been detected in step S5, coincides with a predetermined position in the standard imaging range 185. For example, based on the position, moving direction, and moving speed of the mobile object which have been detected in step S5, the controller 100 estimates the first timing at which the position of the mobile object coincides with the predetermined position in the standard imaging range 185.

The operation of estimating the first timing by the controller 100 will be described below with reference to a wide-angle live view image 350 illustrated in FIG. 7. For the sake of description, the wide-angle live view image 350 (an image showing the object within the wide-angle imaging range 195) illustrated in FIG. 7 is shown in such a manner that a partial area (the partial area showing an object within the standard imaging range 185) 351 corresponding to the standard imaging range 185 is segregated.

The peripheral area of the wide-angle live view image 350 other than the partial area 351 (the area inside the wide-angle imaging range 195 and outside the standard imaging range 185) is divided into an upper area 352, a lower area 353, a left area 354, and a right area 355 by straight lines connecting four vertices, or, upper left, upper right, lower right, and lower left vertices of the wide-angle live view image 350, respectively with four vertices, or, upper left, upper right, lower right, and lower left vertices of the partial area 351.

In the example of FIG. 7, the mobile object 500 moving leftward, such as a vehicle, is shown in the right area 355 of the wide-angle live view image 350.

In step S6, the controller 100 determines whether the moving direction of the mobile object 500, which has been detected in step S5, is the predetermined position in the partial area 351. In the example of FIG. 7, the controller 100 determines whether the moving direction of the mobile object 500, which has been detected in step S5, is the direction toward a central area 351a of the partial area 351. When determining that the mobile object 500 is moving toward the central area 351a, the controller 100 estimates the first timing at which the mobile object enters the central area 351 based on the moving speed of the mobile object which has been detected in step S5. The controller 100 functions as an estimation unit that estimates the first timing at which the detected position of the mobile object coincides with the predetermined position within the standard imaging range 185.

As described above, the controller 100 detects, based on an image signal from the wide-angle camera 190, a mobile object located in the partial area outside the standard imaging range 185 in the wide-angle imaging range 195. The estimation unit estimates the first timing at which the position of the mobile object coincides with the predetermined position within the standard imaging range 185. The controller 100 can accordingly estimate the first timing before the mobile object enters into the standard imaging range 185.

The predetermined position within the standard imaging range 185 at a time when the controller 100 estimates the first timing may be in any area other than the central area 351a illustrated in FIG. 7. For example, the controller 100 may estimate the timing at which the mobile object enters the standard imaging range 185 as the first timing. The predetermined position (predetermined area) within the standard imaging range 185 at a time when the controller 100 estimates the first timing may be stored in the storage 103 in advance through, for example, a user's input operation.

When the controller 100 estimates the first timing in step S6, step S7 is performed. In step S7, the controller 100 notifies the user of the first timing estimated in step S6. For example, the controller 100 controls the display 120 to cause the display screen 2a to display the first notification information for notifying the first timing estimated in step S6. The display 120 functions as a notification unit that notifies the estimated first timing.

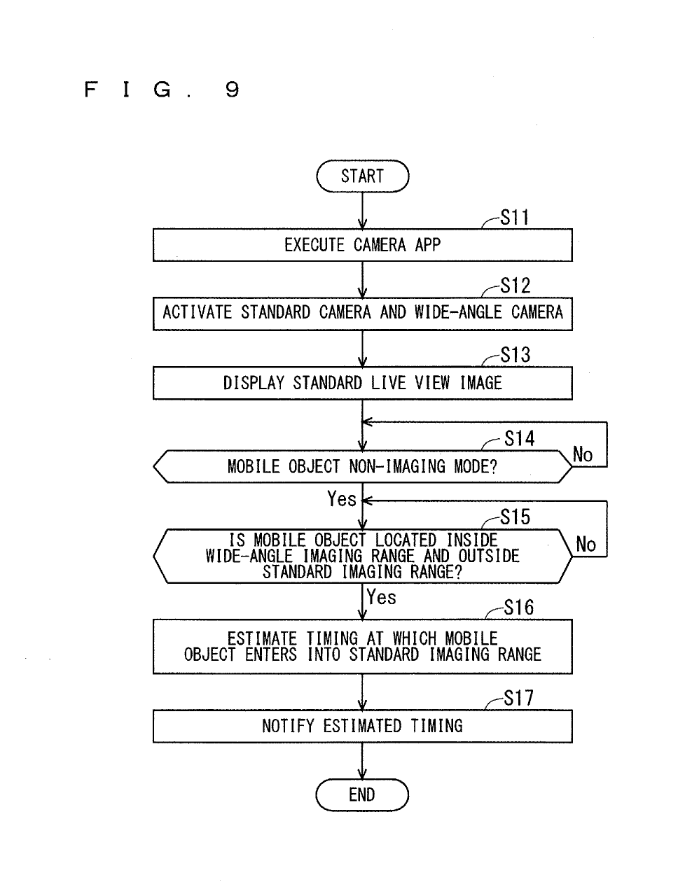

FIG. 8 illustrates an example display of the display screen 2a displaying first notification information 360. FIG. 8 illustrates an example display of the display screen 2a when the wide-angle live view image 350 illustrated in FIG. 7 is obtained. In the example of FIG. 8, the first notification information 360 is displayed at the right end portion of the central area 420 of the display screen 2a. In the example of FIG. 8, the first notification information 360 indicates a remaining time from the current time to the first timing. The controller 100 calculates the time of the estimated first timing based on, for example, time information from the clock unit 210, thereby measuring the remaining time before the first timing.

As described above, the user is notified of the estimated first timing and can accordingly know the timing at which the position of the mobile object coincides with a predetermined position within the standard imaging range 185. The user can thus operate the operation button 310 at the notified first timing to obtain an image at a time when the position of the mobile object coincides with a predetermined position in the standard imaging range 185, or, an image showing the mobile object at the predetermined position in the standard imaging range 185. The user is notified of the first timing and can accordingly know that the mobile object has been detected inside the wide-angle imaging range 195 and outside the standard imaging range 185 and that the mobile object is moving toward the predetermined position in the standard imaging range 185. It can be said that the display 120 functions as a notification unit that notifies that the mobile object has been detected.

At the right end portion of the central area 420 of the display screen 2a, a mobile object image 370 showing the detected mobile object 500 is displayed. The mobile object image 370 is an image of a partial area showing the mobile object 500 in the wide-angle live view image 350. The mobile object image 370 is, for example, displayed on the standard live view image 300 in an overlapping manner

The size of the mobile object image 370 in the display screen 2a may be the size of the unaltered image in the partial area showing the mobile object 500 in the wide-angle live view image 350, or may be scaled down for the user to easily view the standard live view image 300. The size of the mobile object image 370 in the display screen 2a may be scaled up for the user to easily check the mobile object 500 if, for example, the size of the mobile object 500 is small.

As described above, the display screen 2a displays the standard live view image 300 and the mobile object image 370, and thus, the user can check a mobile object with reference to the mobile object image 370 while checking an object in the standard imaging range 185 with reference to the standard live view image 300. The display screen 2a displays the mobile object image 370, and accordingly, the user can know that the mobile object has been detected inside the wide-angle imaging range 195 and outside the standard imaging range 185.

The positions at which the first notification information 360 and the mobile object image 370 are displayed in the display screen 2a change depending on the detected position of the mobile object. For example, when the mobile object is detected in the right area 355 of the wide-angle live view image 350 as illustrated in FIG. 7, as illustrated in FIG. 8, the first notification information 360 and the mobile object image 370 are displayed at the right end portion of the central area 420 of the display screen 2a. When the mobile object is detected in the upper area 352 of the wide-angle live view image 350, the first notification information 360 and the mobile object image 370 are displayed at the upper end portion of the central area 420 of the display screen 2a. When the mobile object is detected in the lower area 353 of the wide-angle live view image 350, the first notification information 360 and the mobile object image 370 are displayed at the lower end portion of the central area 420 of the display screen 2a. When the mobile object is detected in the left area 354 of the wide-angle live view image 350, the first notification information 360 and the mobile object image 370 are displayed at the left end portion of the central area 420 of the display screen 2a.

The positions at which the first notification information 360 and the mobile object image 370 are displayed in the display screen 2a change depending on the detected position of the mobile object, and accordingly, the user can know the position of the mobile object detected inside the wide-angle imaging range 195 and outside the standard imaging range 185.

The number of divisions of the area located inside the wide-angle imaging range 195 and outside the standard imaging range 185 and the area division method are not limited to those of the example of FIG. 7. For example, the positions at which the first notification information 360 and the mobile object image 370 are displayed in the display screen 2a may be determined more precisely by increasing the number of divisions.

The user may be notified of the first timing in any form other than the first notification information 360 displayed on the display screen 2a. For example, the user may be notified of the first timing by a sound output from the external speaker 170. Specifically, the time interval of the sound output intermittently from the external speaker 170 may be changed (e.g., reduced) to notify the user that the first timing approaches. Alternatively, the volume of the sound output from the external speaker 170 may be changed (e.g., increased) to notify the user that the first timing approaches. Still alternatively, the first timing may be notified by a voice output from the external speaker 170, for example, a voice indicating a remaining time before the first timing.

When the electronic apparatus 1 includes a notification lamp comprising LEDs, the time interval of the light intermittently output from the notification lamp may be changed (e.g., reduced) to notify the user that the first timing approaches. Alternatively, the amount or color of the light output from the notification lamp may be changed to notify the user that the first timing approaches.

When the electronic apparatus 1 includes a vibrator comprising a piezoelectric vibration element and a motor, the time interval of the vibration caused by the vibrator intermittently vibrating the electronic apparatus 1 may be changed (e.g., reduced) to notify the user that the first timing approaches. The vibration amount of the electronic apparatus 1 may be changed to notify the user that the first timing approaches.

The first notification information 360 and the mobile object image 370 may be deleted from the display screen 2a when the mobile object enters the partial area 351 of the wide-angle live view image 350.

1-2. Operation of Electronic Apparatus in Mobile Object Non-Imaging Mode

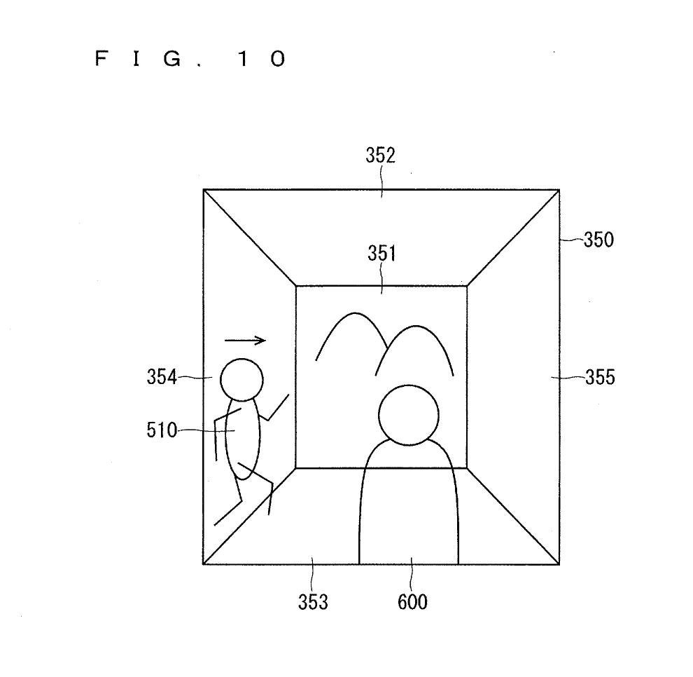

The case in which the electronic apparatus 1 has the mobile object non-imaging mode and the normal imaging mode will now be described. FIG. 9 illustrates a flowchart showing an example operation of the electronic apparatus 1 having the mobile object non-imaging mode and the normal imaging mode.

Processes of steps S11 to S13 and S15 are similar to the processes of steps S1 to S3 and S5 illustrated in FIG. 7, which will not be described here.

In step S14, the controller 100 determines whether the electronic apparatus 1 is operating in the mobile object non-imaging mode. If a negative determination is made in step S14, step S14 is performed again. When not operating in the mobile object non-imaging mode, the electronic apparatus 1 operates in the normal imaging mode.

If an affirmative determination is made in step S14, step S15 is performed. In step S15, the controller 100 determines whether the mobile object is located inside the wide-angle imaging range 195 and outside the standard imaging range 185.

If the controller 100 determines in step S15 that the mobile object is located neither inside the wide-angle imaging range 195 nor outside the standard imaging range 185, step S15 is performed again. In other words, the process of detecting a mobile object is performed every predetermined period of time until the controller 100 determines in step S15 that the mobile object is located inside the wide-angle imaging range 195 and outside the standard imaging range 185.

If the controller 100 determines in step S15 that the mobile object is located inside the wide-angle imaging range 195 and outside the standard imaging range 185, step S16 is performed. In step S16, the controller 100 estimates a second timing at which the mobile object detected in step S15 enters the standard imaging range 185. Similarly to the estimation of the first timing, for example, the controller 100 estimates the second timing at which the mobile object enters the standard imaging range 185 based on the position, moving direction, and moving speed of the mobile object, which have been detected in step S15.

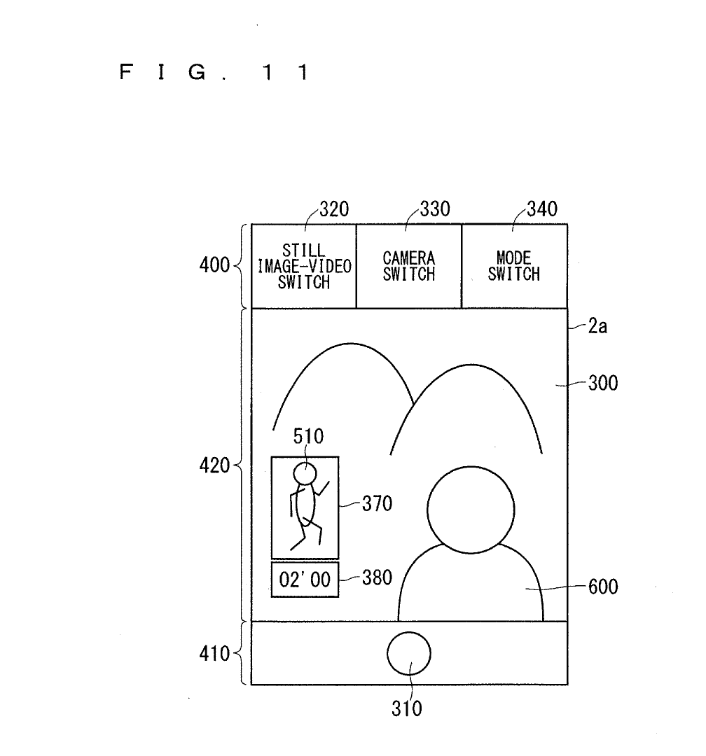

The operation of estimating the second timing by the controller 100 will be described below with reference to a wide-angle live view image 350 illustrated in FIG. 10. In the example of FIG. 10, a target object 600 that the user attempts to image, such as a person, is shown in the partial area 351 and the lower area 353 of the wide-angle live view image 350. A mobile object 510 moving rightward, such as a person, is shown in the left area 354 of the wide-angle live view image 350.

In step S16 illustrated in FIG. 9, the controller 100 determines whether the mobile object 510 is moving toward the partial area 351 based on the moving direction of the mobile object 510, which has been detected in step S15. When determining that the mobile object 510 is moving toward the partial area 351, the controller 100 estimates the second timing at which the mobile object enters the partial area 351 based on the moving speed of the mobile object, which has been detected in step S15. The controller 100 functions as an estimation unit that estimates the second timing at which the mobile object enters into the standard imaging range 185.

As described above, the controller 100 detects, based on an image signal from the wide-angle camera 190, a mobile object located in the partial area outside the standard imaging range 185 in the wide-angle imaging range 195. The estimation unit estimates the second timing at which the mobile object enters into the standard imaging range 185. Thus, the second timing can be estimated before the mobile object enters into the standard imaging range 185.

When the second timing is estimated in step S16, step S17 is performed. In step S17, the controller 100 notifies the second timing estimated in step S16. Specifically, the controller 100 control the display panel 121 to causes the display screen 2a to display the second notification information for notifying the second timing estimated in step S16 together with the standard live view image 300. The display 120 functions as a notification unit that notifies the estimated second timing.

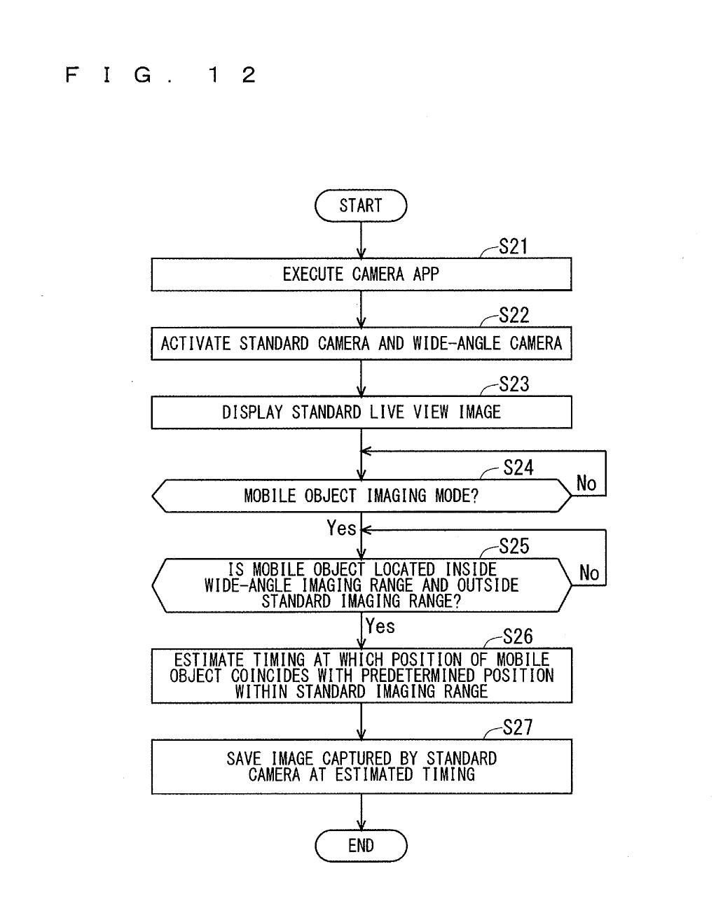

FIG. 11 illustrates an example display of the display screen 2a displaying second notification information 380. FIG. 11 illustrates an example display of the display screen 2a when the wide-angle live view image 350 illustrated in FIG. 10 is obtained. In the example of FIG. 11, the second notification information 380 is displayed together with the mobile object image 370 at the left end portion of the central area 420 of the display screen 2a. In the example of FIG. 11, the second notification information 380 indicates a remaining time from the current time to the second timing. The controller 100 calculates the time of the estimated second timing based on, for example, the time information from the clock unit 210 to measure the remaining time before the second timing.

As described above, the user is notified of the estimated second timing and can accordingly know the second timing at which the mobile object enters the standard imaging range 185. The user thus can operate the operation button 310 before the to-be-notified second timing to obtain an image at a time before the mobile object enters the standard imaging range 185, or, an image showing no mobile object in the standard imaging range 185. The user is notified of the second timing and can accordingly know that a mobile object has been detected inside the wide-angle imaging range 195 and outside the standard imaging range 185 and that the mobile object is moving toward the standard imaging range 185. It can also be said that the display 120 functions as a notification unit that notifies that a mobile object has been detected.

The positions at which the second notification information 380 and the mobile object image 370 are displayed in the display screen 2a change depending on the detected position of the mobile object. As illustrated in FIG. 10, when the mobile object 510 is detected in the left area 354 of the wide-angle live view image 350, as illustrated in FIG. 11, the second notification information 380 and the mobile object image 370 are displayed at the left end portion of the central area 420 of the display screen 2a.

The second timing may be notified by, for example, a sound, light, or vibration, similarly to the first timing

Although the example above has described the case in which the electronic apparatus 1 has the mobile object imaging mode and the normal imaging mode and the case in which the electronic apparatus 1 has the mobile object non-imaging mode and the normal imaging mode, the electronic apparatus 1 may have three modes including the mobile object imaging mode, the mobile object non-imaging mode, and the normal imaging mode. In this case, if a negative determination is made in step S4 illustrated in FIG. 5, step S4 is not performed again, but the controller 100 determines whether the electronic apparatus 1 is operating in the mobile object non-imaging mode. If the controller 100 determines that the electronic apparatus 1 is not operating in the mobile object non-imaging mode, the electronic apparatus 1 operates in the normal imaging mode. If the controller 100 determines that the electronic apparatus 1 is operating in the mobile object non-imaging mode, a series of processes from step S15 illustrated in FIG. 9 are performed.

### Second Embodiment

In one embodiment, the electronic apparatus 1 saves a still image captured by the standard camera 180 at the first timing without notifying a first timing estimated by the estimation unit. Also, the electronic apparatus 1 saves a still image captured by the standard camera 180 before the second timing without notifying a second timing estimated by the estimation unit.

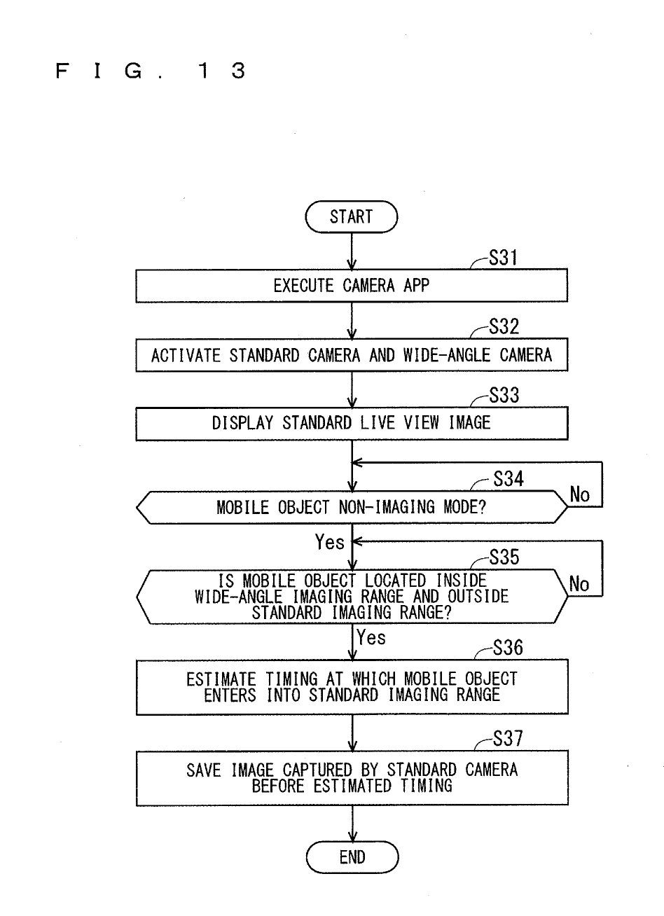

FIG. 12 illustrates a flowchart showing an example operation of the electronic apparatus 1 according to one embodiment. FIG. 12 illustrates a case in which the electronic apparatus 1 has the mobile object imaging mode and the normal imaging mode.

Processes of steps S21 to S26 are similar to the processes of steps S1 to S6 illustrated in FIG. 5, which will not be described here.

When the first timing at which the position of the mobile object coincides with a predetermined position within the standard imaging range 185 is estimated in step S26, step S27 is performed. In step S27, the controller 100 saves in the storage 103 an image captured by the standard camera 180 at the first timing The controller 100 functions as a save unit that saves, in the storage 103, an image captured by the standard camera 180 at the first timing.

As described above, even when the user does not operate the operation button 310, the controller 100 automatically saves an image captured by the standard camera 180 at the estimated first timing. Thus, the standard camera 180 can more easily obtain an image at a time when the position of the mobile object coincides with a predetermined position within the standard imaging range 185, or, an image showing a mobile object at the predetermined position in the standard imaging range 185.

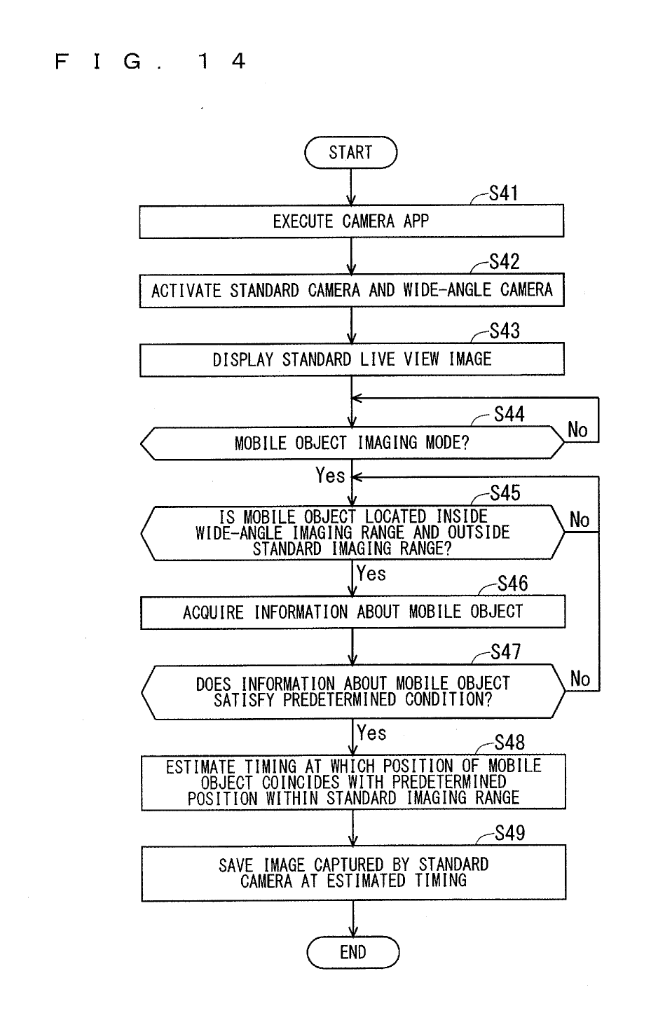

Next, the case in which the electronic apparatus 1 has the mobile object non-imaging mode and the normal imaging mode will be described. FIG. 13 illustrates a flowchart showing an example operation of the electronic apparatus 1 having the mobile object non-imaging mode and the normal imaging mode. Processes of steps S31 to S36 are similar to the processes of steps S11 to S16 illustrated in FIG. 9, which will not be described here.

When the second timing at which the position of the mobile object enters into the standard imaging range 185 is estimated in step S36, step S37 is performed. In step S37, the controller 100 saves in the storage 103 an image captured by the standard camera 180 before the second timing. For example, the controller 100 saves in the storage 103 an image captured by the standard camera 180 immediately before the mobile object enters into the standard imaging range 185. The controller 100 functions as a save unit that saves, in the storage 103, an image captured by the standard camera 180 before the second timing.

As described above, even when the user does not operate the operation button 310, the controller 100 saves an image captured by the standard camera 180 before the second timing estimated by the estimation unit. Thus, the standard camera 180 can more easily obtain an image before the mobile object enters into the standard imaging range 185, or, an image showing no mobile object moving toward the standard imaging range 185.

When the user operates the operation button 310 to save the image before steps S27 and S37 are performed, steps S27 and S37 may not be performed.

Also in one embodiment, the electronic apparatus 1 may have three modes including the mobile object imaging mode, the mobile object non-imaging mode, and the normal imaging mode. In this case, if a negative determination is made in step S24 illustrated in FIG. 12, step S24 is not performed again, but the controller 100 determines whether the electronic apparatus 1 is operating in the mobile object non-imaging mode. If the controller 100 determines that the electronic apparatus 1 is not operating in the mobile object non-imaging mode, the electronic apparatus 1 operates in the normal imaging mode. If the controller 100 determines that the electronic apparatus 1 is operating in the mobile object non-imaging mode, a series of processes from step S35 illustrated in FIG. 13 are performed.

Modifications

Various modifications will be described below.

First Modification

Although the estimated first timing is notified or an image is saved at the estimated first timing in the examples above, in one modification, an estimated first timing is notified, and also, an image is saved at the estimated first timing. For example, the estimated first timing is notified in step S7 illustrated in FIG. 5, and then, step S27 illustrated in FIG. 12 is performed, so that an image captured by the standard camera 180 is saved at the estimated first timing.

Although the estimated second timing is notified or an image is saved before the estimated second timing in the examples above, in one modification, an estimated second timing is notified, and also, an image is saved before the estimated second timing. For example, an estimated second timing is notified in step S17 illustrated in FIG. 9, and then, step S37 illustrated in FIG. 13 is performed, so that an image captured by the standard camera 180 is saved before the estimated second timing.

Second Modification

Although the first and second timings are estimated for a mobile object detected inside the wide-angle imaging range 195 and outside the standard imaging range 185 in the examples above, in one modification, the first and second timings are estimated when the detected mobile object satisfies a predetermined condition, and the first and second timings are not estimated when the detected mobile object does not satisfy the predetermined condition.

FIG. 14 illustrates a flowchart showing an example operation of the electronic apparatus 1 according to one modification. FIG. 14 illustrates the case in which the electronic apparatus 1 has the mobile object imaging mode and the normal imaging mode.

Processes of steps S41 to S45 are similar to the processes of steps S21 to S25 illustrated in FIG. 12, which will not be described here.

If the controller 100 determines in step S45 that the mobile object is located inside the wide-angle imaging range 195 and outside the standard imaging range 185, step S46 is performed. In step S46, the controller 100 acquires the information about the mobile object detected in step S45. The controller 100 functions as an acquisition unit that acquires the information about the mobile object. In step S47, then, the controller 100 determines whether the information about the mobile object, which has been acquired in step S46, satisfies a predetermined condition. The controller 100 functions as a determination unit that determines whether the information about the mobile object satisfies the predetermined condition. Hereinafter, the condition used in determination in step S47 may also be referred to as a “determination condition”.

Examples of the information about the mobile object acquired in step S46 include the size, color, and moving speed of a mobile object. In the detection of a mobile object, for example, a mobile object is detected based on a rectangular area surrounding the mobile object in an input image or an area surrounded by the contour of the mobile object. The size of the mobile object is detected, for example, based on the size of the rectangular area surrounding the mobile object or the area surrounded by the contour of the mobile object when the mobile object is detected. The color of the mobile object is detected, for example, based on an average color or the most frequent color in the rectangular area surrounding the mobile object or the area surrounded by the contour of the mobile object when the mobile object is detected. The moving speed detected in the process of step S45 is used as the moving speed of the mobile object.

In step S47, then, the controller 100 determines, for example, whether the size of the mobile object is greater than or equal to a predetermined value. The controller 100 determines whether the color of the mobile object is a predetermined color or a color similar to the predetermined color. The controller 100 determines whether the moving speed of the mobile object is greater than or equal to a predetermined value. The determination condition may be one condition or a combination of two or more conditions. For example, the determination condition may be a combination of two or more conditions that are based on the size, color, and moving speed of the mobile object. The determination condition may be stored in the storage 103 in advance through, for example, a user's input operation.

A known image recognition technology such as template matching may be used to determine whether a mobile object is an object of specific type. For example, a face recognition technology may be used to determine whether a mobile object is a person or whether a mobile object is a specific person. Alternatively, an image recognition technology may be used to determine whether a mobile object is an animal other than a person or whether a mobile object is a vehicle such as a bicycle.

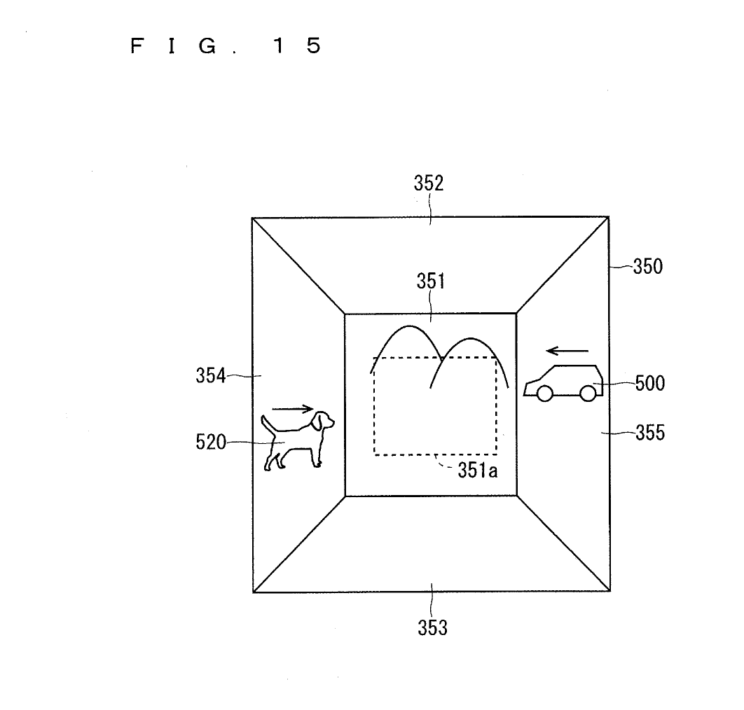

Hereinafter, the operation of determining, by the controller 100, whether the information about a mobile object satisfies a predetermined condition will be described with reference to the wide-angle live view image 350 illustrated in FIG. 15. In the example of FIG. 15, the mobile object 500 moving toward the central area 351a, such as a vehicle, is shown in the right area 355 of the wide-angle live view image 350. A mobile object 520 moving toward the central area 351a, such as a dog, is shown in the left area 354 of the wide-angle live view image 350. In the wide-angle live view image 350, the moving speed of the mobile object 500 is faster than the moving speed of the mobile object 520.

When attempting to image the mobile object 500, the user sets as the determination condition, for example, a condition in which the speed of a mobile object is greater than or equal to a predetermined value. Alternatively, as to the determination condition, whether a mobile object is a vehicle is determined by the image recognition technology.

If the controller 100 determines in step S47 of FIG. 14 that the information about the mobile object does not satisfy a predetermined condition, step S45 is performed again. In other words, a series of processes of steps S45 to S47 are performed repeatedly until the control 100 determines in step S47 that the information about the mobile object satisfies the predetermined condition. The series of processes are performed, for example, every predetermined period of time.

If the controller 100 determines in step S47 that the information about the mobile object satisfies the predetermined condition, step S48 is performed. In step S48, the controller 100 estimates a first timing at which the mobile object, which satisfies the predetermined condition in step S47, is located at a predetermined position within the standard imaging range 185. In step S49, then, the controller 100 saves an image captured by the standard camera 180 at the estimated first timing for the mobile object that satisfies the predetermined condition in step S47. Processes of steps S48 and S49 are similar to the processes of steps S26 and S27 of FIG. 12, which will not be described here.

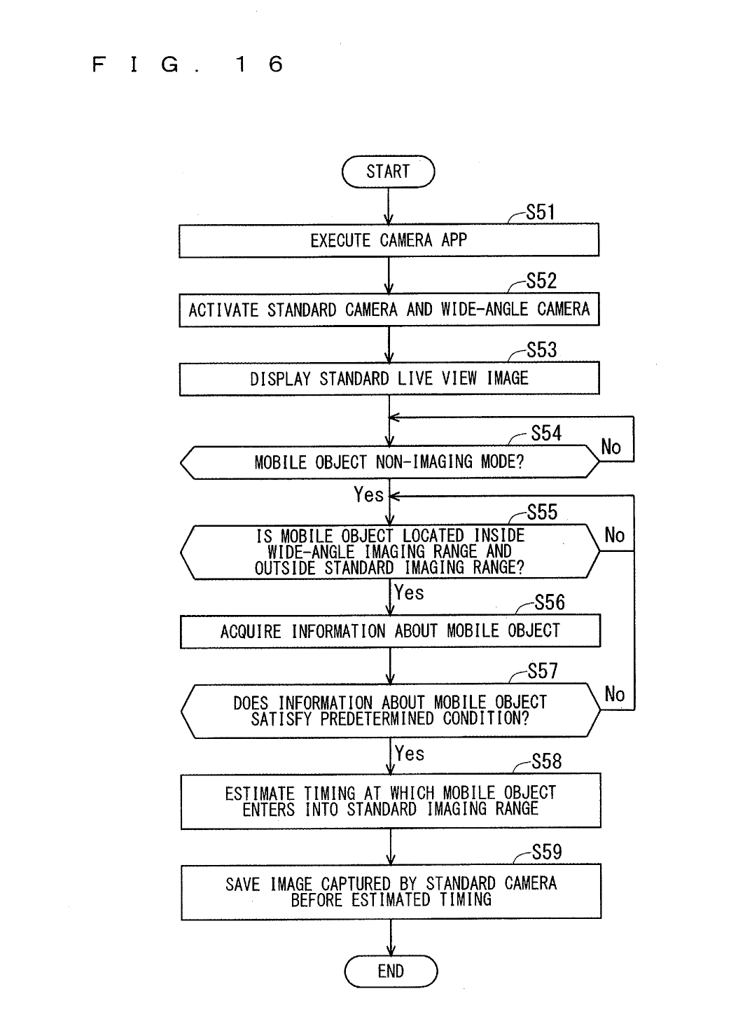

When the wide-angle live view image 350 as illustrated in FIG. 15 is obtained, for example, the controller 100 determines in step S47 that the mobile object 500 satisfies the predetermined condition and that the mobile object 520 does not satisfy the predetermined condition. In this case, in step S49, an image obtained when the position of the mobile object 500 coincides with the predetermined position within the standard imaging range 185 is saved. Since the mobile object 520, however, does not satisfy the predetermined condition in step S47, an image is not saved when the position of the mobile object 520 merely coincides with the predetermined position within the standard imaging range 185. The following will describe the case in which the electronic apparatus 1 has the mobile object non-imaging mode and the normal imaging mode. FIG. 16 illustrates a flowchart showing an example operation of the electronic apparatus 1 having the mobile object non-imaging mode and the normal imaging mode. Processes of steps S51 to S55 are similar to the processes of steps S31 to S35 illustrated in FIG. 13, which will not be described here.

When the controller 100 determines in step S55 that the mobile object is located inside the wide-angle imaging range 195 and outside the standard imaging range 185, step S56 is performed. In step S56, the controller acquires the information about the mobile object, which has been detected in step S55. In step S57, then, the controller 100 determines whether the information about the mobile object, which has been acquired in step S56, satisfies a predetermined condition. Processes of steps S56 and S57 are similar to the processes of steps S46 and S47 of FIG. 14, which will not be described here.

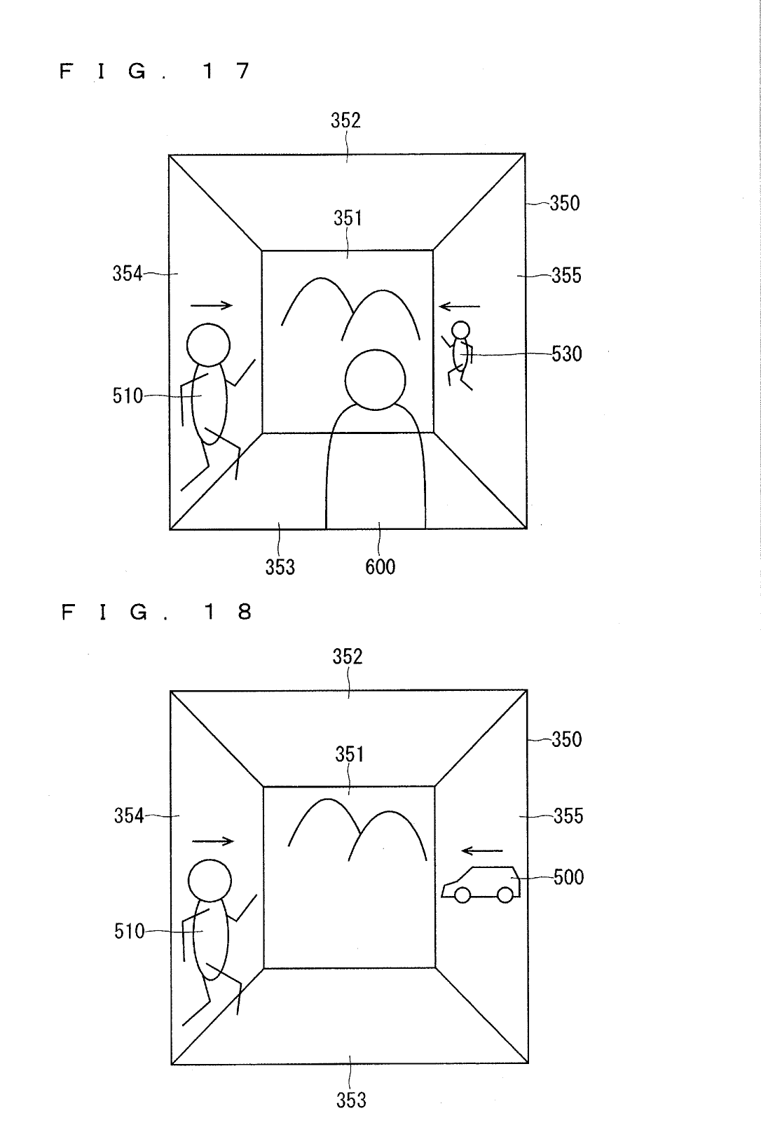

An operation of determining, by the controller 100, whether the information about a mobile object satisfies a predetermined condition will be described with reference to the wide-angle live view image 350 illustrated in FIG. 17. In the example of FIG. 17, a target object 600 that the user attempts to image, such as a person, is shown in the partial area 351 and the lower area 353 of the wide-angle live view image 350. A mobile object 530 moving toward the central area 351a, such as a person, is shown in the right area 355 of the wide-angle live view image 350. The mobile object 510 moving toward the central area 351a, such as a person, is shown in the left area 354 of the wide-angle live view image 350. In the wide-angle live view image 350, the size of the mobile object 510 is larger than that of the mobile object 530.

When the user images the target object 600, for example, for a relatively small mobile object, in some cases, the controller 100 determines that the mobile object may be shown in the standard imaging range 185. In the example of FIG. 17, a determination condition in step S57 is set such that the second timing is not estimated for the mobile object 530 and the second timing is estimated for the mobile object 510. For example, a condition in which the size of the mobile object is greater than a predetermined value is adopted as the determination condition.

If the controller 100 determines in step S57 that the information about the mobile object does not satisfy the predetermined condition, step S55 is performed again. In other words, a series of processes of steps S55 to S57 are repeatedly performed until the processor 100 determines in step S57 that the information about the mobile object satisfies the predetermined condition. The series of processes are performed, for example, every predetermined period of time.

If the controller 100 determines in step S57 that the information about the mobile object satisfies the predetermined condition, step S58 is performed. In step S58, the controller 100 estimates the second timing at which the mobile object that satisfies the predetermined condition in step S57 enters into the standard imaging range 185. In step S59, then, the controller 100 saves an image captured by the standard camera 180 before the second timing estimated for the mobile object that satisfies the predetermined condition in step S57. Processes of steps S58 and S59 are similar to the processes of steps S36 and S37 of FIG. 13, which will not be described here.

When the wide-angle live view image 350 as illustrated in FIG. 17 is obtained, for example, the controller 100 determines in step S57 that the mobile object 510 satisfies a predetermined condition and that the mobile object 530 does not satisfy the predetermined condition. In this case, in step S59, an image before the mobile object 510 enters into the standard imaging range 185 is saved. This image may show the mobile object 530.

As described above, the controller 100 estimates at least one of the first and second timings for the mobile object, information about which satisfies the predetermined condition, and does not estimate the first and second timings for the mobile object, information about which does not satisfy the predetermined condition. The load in the estimation process by the controller 100 can thus be reduced.

Also when at least-one of the first and second timings is notified, at least one of the first and second timings is notified for a mobile object that satisfies a predetermined condition and the first and second timings are not notified for a mobile object that does not satisfy the predetermined condition. Also when it is notified that a mobile object has been detected, it is determined that a mobile object has been detected for a mobile object that satisfies a predetermined condition, and it is not notified that a mobile object has been detected for a mobile object that does not satisfy the predetermined condition. Also when the mobile object image 370 is displayed, the mobile object image 370 is displayed for a mobile object that satisfies a predetermined condition, and the mobile object image 370 is not displayed for a mobile object that does not satisfy the predetermined condition.

As described above, the user is notified of a mobile object that satisfies a predetermined condition and is not notified of a mobile object that does not satisfy the predetermined condition, and thus, can more easily recognize the notification of the mobile object that satisfies the predetermined condition.

Also in the second modification, the electronic apparatus 1 may have three modes including the mobile object imaging mode, the mobile object non-imaging mode, and the normal imaging mode. In this case, if a negative determination is made in step S44 illustrated in FIG. 14, step S44 is not performed again, but the controller 100 determines whether the electronic apparatus 1 is operating in the mobile object non-imaging mode. If the controller 100 determines that the electronic apparatus 1 is not operating in the mobile object non-imaging mode, the electronic apparatus 1 operates in the normal imaging mode. If the controller 100 determines that the electronic apparatus 1 operates in the mobile object non-imaging mode, a series of processes from step S55 illustrated in FIG. 16 are performed.

Third Modification

In the examples above, the determination condition is stored in the storage 103 in advance through a user's input operation, and whether the mobile object satisfies the determination condition is determined. In one modification, a mobile object is detected, and then, the mobile object is set as a mobile object that satisfies or does not satisfy the determination condition.

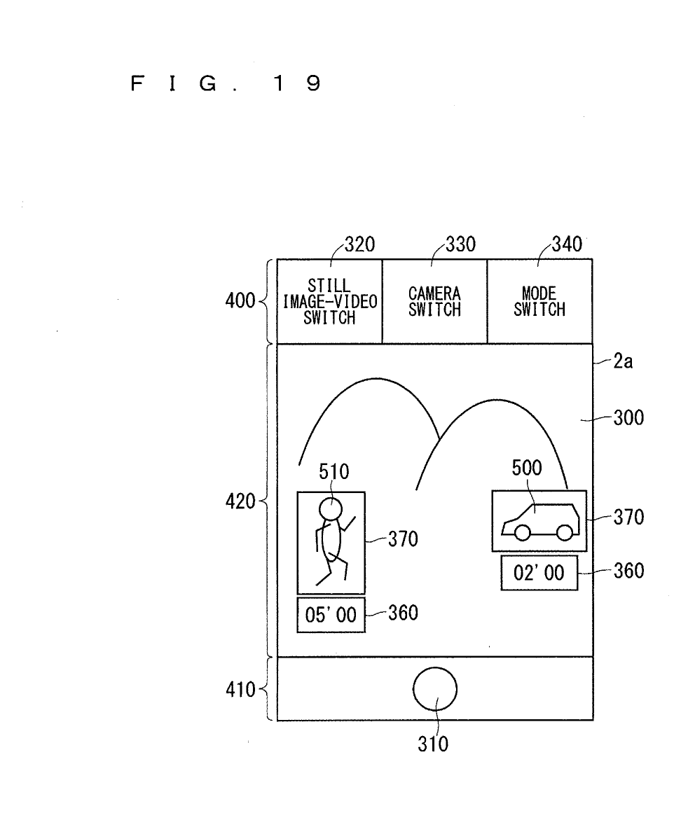

The operation performed when the determination condition is set after the detection of a mobile object will be described with reference to FIGS. 18 to 20.

FIG. 18 illustrates an example of the wide-angle live view image 350. In the example of FIG. 18, the mobile object 500 moving leftward, such as a vehicle, is shown in the right area 355 of the wide-angle live view image 350. Also, the mobile object 510 moving rightward, such as a person, is shown in the left area 354 of the wide-angle live view image 350. The determination condition is not set at this time.

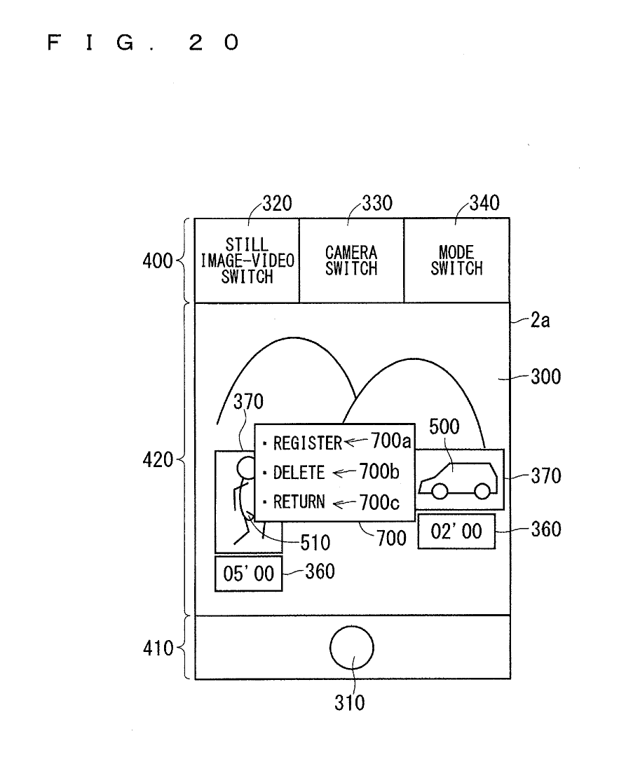

When the wide-angle live view image 350 as illustrated in FIG. 18 is obtained, a screen as illustrated in FIG. 19 is displayed on the display screen 2a. With reference to FIG. 19, the first notification information 360 and the mobile object image 370 for the mobile object 500 are displayed at the right end portion of the central area 420 of the display screen 2a. The first notification information 360 and the mobile object image 370 for the mobile object 510 are displayed at the left end portion of the central area 420 of the display screen 2a.

The user can set a mobile object as a mobile object that satisfies the determination condition or a mobile object that does not satisfy the determination condition through the selection operation on the mobile object image 370. When the screen as illustrated in FIG. 19 is displayed on the display screen 2a, the user can set the determination condition through the selection operation on the mobile object image 370 for the mobile object 510. When the user performs the selection operation on the mobile object image 370 for the mobile object 510, as illustrated in FIG. 20, a menu screen 700 for the mobile object 510 is displayed on the display screen 2a. In the example of FIG. 20, the menu screen 700 displays a register button 700a, a delete button 700b, and a return button 700c.

The register button 700a is a button for setting the mobile object 510 as the mobile object that satisfies a predetermined condition. The delete button 700b is a button for setting the mobile object 510 as the mobile object that does not satisfy the predetermined condition. The return button 700c is a button for deleting a display of the menu screen 700.

When the register button 700a is operated, the storage 103 stores the information about the mobile object 510, for example, the size, color, moving speed, image, and the like of the mobile object 510. Then, even when the mobile object 510 moves out of the wide-angle imaging range 195 and subsequently moves toward the standard imaging range 185 again, it is determined that the mobile object 510 is the mobile object that satisfies a predetermined condition based on the information about the mobile object 510 which is stored in the storage 103. Even when a camera app is terminated once and the camera app is activated again, if the mobile object 510 is detected again, it may be determined that the mobile object 510 is the mobile object that satisfies the predetermined condition based on the information about the mobile object 510, which is stored in the storage 103.

When the delete button 700b is operated, the storage 103 stores the information about the mobile object 510, for example, the size, color, moving speed, image, and the like of the mobile object 510. Then, even when the mobile object 510 moves out of the wide-angle imaging range 195 and subsequently moves toward the standard imaging range 185 again, it is determined that the mobile object 510 is the mobile object that does not satisfy the predetermined condition based on the information about the mobile object 510, which is stored in the storage 103. Even when a camera app is terminated once and the camera app is activated again, if the mobile object 510 is detected again, it may be determined that the mobile object 510 is the mobile object that does not satisfy the predetermined condition based on the information about the mobile object 510, which is stored in the storage 103. When the delete button 700b is operated, the displays of the first notification information 360 and the mobile object image 370 for the mobile object 510 disappear.

As described above, a simple method, or, the selection operation on the mobile object image 370 can set a mobile object shown in the mobile object image 370 as a mobile object that satisfies a predetermined condition or a mobile object that does not satisfy the predetermined condition. The user can check a mobile object shown in the mobile object image 370 and then set the mobile object as a mobile object that satisfies a predetermined condition or a mobile object that does not satisfy the predetermined condition, and thus, can more reliably set a target to be imaged or a target that the user does not want to image.

Although the examples above have described the cases in which the technology of the present disclosure is applied to mobile phones such as smartphones, the technology of the present disclosure is also applicable to other electronic apparatuses including a plurality of imaging units with different angles of view. For example, the technology of the present disclosure is also applicable to electronic apparatuses such as digital cameras, personal computers, and tablet terminals.

While the electronic apparatus 1 has been described above in detail, the above description is in all aspects illustrative and not restrictive, and the present disclosure is not limited thereto. The modifications described above are applicable in combination as long as they are not mutually inconsistent. It is understood that numerous modifications which have not been exemplified can be devised without departing from the scope of the present disclosure.

What is claimed is:

1. An electronic apparatus comprising:
a first camera configured to image a first imaging range;
a second camera configured to image a second imaging range having an angle wider than an angle of the first imaging range; and
at least one processor configured to
detect, based on an image signal from the second camera, a mobile object located in a partial area outside the first imaging range in the second imaging range, and
estimate at least one of a first timing at which a position of the mobile object coincides with a predetermined position within the first imaging range and a second timing at which the mobile object enters into the first imaging range.

2. The electronic apparatus according to claim 1, wherein the at least one processor is configured to
estimate the first timing, and
save an image captured by the first camera at the first timing.

3. The electronic apparatus according to claim 1, wherein the at least one processor is configured to
estimate the second timing, and
save an image captured by the first camera before the second timing.

4. The electronic apparatus according to claim 1, further comprising
a notification unit configured to notify at least one of the first and second timings estimated by the at least one processor.

5. The electronic apparatus according to claim 1, further comprising
a notification unit configured to notify that the at least one processor has detected the mobile object.

6. The electronic apparatus according to claim 1, further comprising
a display configured to display a live view image captured by the first camera and an image showing the mobile object captured by the second camera.

7. The electronic apparatus according to claim 1, wherein the at least one processor is configured to
acquire information about the detected mobile object,
estimate at least one of the first and second timings for the mobile object, the information about the mobile object satisfying a predetermined condition, and
not estimate the first and second timings for the mobile object, the information about the mobile object not satisfying the predetermined condition.

8. The electronic apparatus according to claim 4, wherein
the at least one processor acquires information about the detected mobile object, and
the notification unit is configured to
notify at least one of the first and second timings estimated by the at least one processor for the mobile object, the information about the mobile object satisfying a predetermined condition, and
not notify the first and second timings estimated by the at least one processor for the mobile object, the information about the mobile object not satisfying the predetermined condition.

9. The electronic apparatus according to claim 5, wherein
the at least one processor acquires information about the detected mobile object, and
the notification unit is configured to
notify that the mobile object has been detected, the information about the mobile object satisfying a predetermined condition, and
not notify that the mobile object has been detected, the information about the mobile object not satisfying the predetermined condition.

10. The electronic apparatus according to claim 6, wherein
the at least one processor acquires information about the detected mobile object, and
the display is configured to
display the image together with the live view image for the mobile object, the information about the mobile object satisfying a predetermined condition, and
not display the image for the mobile object, the information about the mobile object not satisfying the predetermined condition.

11. An imaging method comprising
imaging a first imaging range by a first camera;
imaging a second imaging range having an angle wider than an angle of the first imaging range by a second camera;
detecting, based on an image signal from the second camera, a mobile object located in a partial area outside the first imaging range in the second imaging range; and
estimating at least one of a first timing at which a position of the mobile object coincides with a predetermined position within the first imaging range and a second timing at which the mobile object enters into the first imaging range.

12. A non-transitory computer readable recording medium that stores a control program for controlling an electronic apparatus including a first camera configured to image a first imaging range and a second camera configured to image a second imaging range having an angle wider than an angle of the first imaging range, the control program causing the electronic apparatus to execute the steps of:
detecting, based on an image signal from the second camera, a mobile object located in a partial area outside the first imaging range in the second imaging range; and
estimating at least one of a first timing at which a position of the mobile object coincides with a predetermined position within the first imaging range and a second timing at which the mobile object enters into the first imaging range.
